(19) United States
(12) Patent Application Publication
(10) Pub. No.: US 2005/0282040 A1
(43) Pub. Date: Dec. 22, 2005

(54) Magnetic recording medium

(75) Inventors: Masahito Oyanagi, Kanagawa (JP); Takeshi Harasawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/145,974

(22) Filed: Jun. 7, 2005

(30) Foreign Application Priority Data
Jun. 8, 2004 (JP) 2004-169654

(51) Int. Cl. G11B 5/716

(52) U.S. Cl. 428/840; 428/842.8

(57) ABSTRACT

Provided is a magnetic recording medium having excellent surface smoothness and coating durability. The magnetic recording medium comprises an undercoating layer comprising a radiation-curing resin as a main component and a magnetic layer comprising a ferromagnetic powder and a binder in this order on a nonmagnetic support. The undercoating layer comprises no particulate matter, and the magnetic layer comprises a diamond powder.

### CROSS-REFERENCE TO RELATED APPLICATIONS

This application claims benefit of priority under 35 USC 119 to Japanese Patent Application No. 2004-169654 filed on Jun. 8, 2004.

### FIELD OF THE INVENTION

The present invention relates to a particulate magnetic recording medium having excellent surface smoothness and coating durability.

In recent years, as magnetic recording media have achieved higher recording densities, recording wavelengths have tended to become shorter. The problem of self-demagnetization loss during recording, where output is decreased by a thick magnetic layer, has come to the fore. As a result, the magnetic layer has been made thinner. However, when a thinner magnetic layer is directly coated on a support, additives such as abrasives and carbon in the magnetic layer, aggregates of magnetic powders, and the nonmagnetic support cause roughness of the surface of the magnetic layer, resulting in the problems of deterioration of electromagnetic characteristics and greater dropout.

Providing a nonmagnetic layer between the support and magnetic layer has been proposed and implemented as one method of solving this problem. Providing a masking layer containing carbon black between the support and magnetic layer has also been proposed (see Japanese Unexamined Patent Publication (KOKAI) Heisei No. 6-28661).

Dispersion techniques and coating techniques have advanced in recent years, permitting the formation of smooth, thin magnetic layers. The smoothness of the medium is now affected by the surface property of the lower layer positioned under the magnetic layer. Thus, there are problems in that surface roughness of the lower layer and protrusions on the surface of the lower layer degrade the surface smoothness of the magnetic layer, and electromagnetic characteristics deteriorate.

Smoothing of the magnetic layer is desirable to achieve good electromagnetic characteristics, but there is a problem in that the smoother the magnetic layer becomes, the more coating durability deteriorates.

It is an object of the present invention to provide a magnetic recording medium having excellent surface smoothness and coating durability.

The present inventors conducted extensive research into how to achieve the above-stated object. This resulted in the discovery that providing an undercoating layer comprising a radiation-curing resin as a main component between a nonmagnetic support and a magnetic layer yielded a magnetic layer having excellent surface smoothness. The present inventors further discovered that incorporating a diamond powder into the magnetic layer resulted in a magnetic layer having excellent surface smoothness while also affording good coating durability. The present invention has been devised on that basis.

### SUMMARY OF THE INVENTION

The aforementioned object of the present invention can be achieved by;
a magnetic recording medium comprising an undercoating layer comprising a radiation-curing resin as a main component and a magnetic layer comprising a ferromagnetic powder and a binder in this order on a nonmagnetic support, wherein
said undercoating layer comprises no particulate matter, and
said magnetic layer comprises a diamond powder.

Where the thickness of the magnetic layer is denoted as d (nm), the diamond powder preferably has a mean particle diameter ranging from 0.7 d to 1.3 d (nm).

The thickness of the magnetic layer preferably ranges from 30 to 200 nm.

The magnetic layer preferably has a surface roughness Ra equal to or less than 2 nm.

The ferromagnetic powder comprised in the magnetic layer is preferably a hexagonal ferrite powder having a mean plate diameter ranging from 10 to 35 nm or a ferromagnetic metal powder having a mean major axis length ranging from 20 to 70 nm.

The present invention will be described in detail below.

The magnetic recording medium of the present invention comprises an undercoating layer comprising a radiation-curing resin as a main component and a magnetic layer comprising a ferromagnetic powder and a binder in this order on a nonmagnetic support, wherein said undercoating layer comprises no particulate matter, and said magnetic layer comprises a diamond powder.

[Undercoating Layer]

The magnetic recording medium of the present invention comprises a nonmagnetic support, an undercoating layer comprising a radiation-curing resin as a main component positioned thereover, and a magnetic layer positioned over this undercoating layer.

The effect achieved in the present invention by providing an undercoating layer comprising a radiation-curing resin as a main component between a nonmagnetic support and a magnetic layer will be described below.

The radiation-curing resin employed in the undercoating layer has the property of polymerizing or crosslinking to form polymers and cure when exposed to energy in the form of radiation such as an electron beam or ultraviolet radiation. Since the radiation-curing resin does not react until such energy is applied, the coating liquid containing a radiation-curing resin is of a relatively low viscosity that remains stable prior to exposure to radiation. Thus, after coating a coating liquid for the undercoating layer on a nonmagnetic support, until the coating liquid dries, the roughness and protrusions of the nonmagnetic support surface are masked by the leveling effect, yielding a smooth undercoating layer. Applying a magnetic layer coating liquid on a smooth undercoating layer yields a magnetic layer of high surface smoothness. It is thus possible to obtain a magnetic recording medium with good electromagnetic characteristics. Further, since the radiation-curing resin undergoes an instantaneous reaction when exposed to a high level of energy, it is possible to obtain an undercoating layer of high coating strength, and thus, to increase the strength of the magnetic recording medium. These effects are particularly marked in magnetic recording media having thin magnetic layers ranging from 30 to 200 nm in thickness, for example. By providing the above undercoating layer, it is possible to achieve an effect in the form of a reduction in the minute protrusions on the magnetic layer surface that tend to generate noise in magnetic recording media employing MR heads that have accompanied the shift to high recording densities in recent years.

The above undercoating layer comprises no particulate matter. Here, the term “particulate matter” refers to the organic and inorganic particulate matter commonly employed in magnetic layers, nonmagnetic layers, backcoat layers and the like. Examples are metal oxides such as hematite, magnetite, maghemite, berthollide compounds, barium ferrite compounds, goethite, TiO₂, alumina, and boehmite; carbon black; metallic and ferromagnetic metal powders; Fe, FeCo alloys, FePt alloys, and CoPt alloys; and hexagonal ferrite powders.

Since particulate matter—such as in the above examples—disperses poorly, when a magnetic layer is applied over a layer comprising such particulate matter, the surface properties of lower layers degrade the surface smoothness of the magnetic layer. Accordingly, in the present invention, providing a magnetic layer on an undercoating layer comprising no particulate matter permits the formation of a magnetic layer of excellent surface smoothness through the above-mentioned masking effect by the undercoating layer.

From the perspective of obtaining a good masking effect, the viscosity of the radiation-curing resin employed in the undercoating layer is preferably equal to or less than 200 mPa·s, more preferably from 5 to 150 mPa·s, and further preferably from 5 to 100 mPa·s. Here, the viscosity of the radiation-curing resin is the viscosity of the resin component (without solvent) as measured at 25° C. prior to radiation curing. The weight average molecular weight of the radiation-curing resin is preferably from 200 to 1,000, more preferably from 200 to 500.

Examples of the radiation-curing resin are acrylic esters, acrylamides, methacrylic esters, methacrylamides, allyl compounds, vinyl ethers, and vinyl esters. Of these, the acrylic esters and methacrylic esters are preferred, with acrylic esters having two or more radiation-curing functional groups being particularly preferred. Examples of radiation-curing functional groups are acryloyl and methacryloyl groups, with acryloyl groups being preferred.

The radiation-curing resin preferably has an alicyclic ring structure. The term “alicyclic ring structure” is a structure comprising a cycloskeleton, bicycloskeleton, tricycloskeleton, spiroskeleton, dispiroskeleton, or the like. Of these, alicyclic ring structures comprised of multiple rings that share atoms, such as bicyloskeleton, tricycloskeleton, spiroskeleton, and dispiroskeleton structures, are preferred. Examples of such skeletons are those, such as esters and amides, that become the residues of the polyols and polyamines for the formation of radiation-curing resins. The radiation-curing resin can be comprised of various radiation-curing functional groups bound to such residues.

Since radiation-curing resins comprising an alicyclic ring structure have higher glass transition temperatures than aliphatic ones, it is possible to reduce viscosity-induced defects in steps following application of the undercoating layer. Further, employing a cyclohexane ring or a bicyclo, tricyclo, spiro, or similar alicyclic skeleton reduces coating contraction during curing and enhances adhesion to the nonmagnetic support.

Specific examples of radiation-curing resins are: cyclopropane diacrylate, cyclopentane diacrylate, cyclohexane diacrylate, cyclobutane diacrylate, dimethylolcyclopropane diacrylate, dimethylolcyclopentane diacrylate, dimethylolcyclohexane diacrylate, dimethylolcyclobutane diacrylate, cyclopropane dimethacrylate, cyclopentane dimethacrylate, cyclohexane dimethacrylate, cyclobutane dimethacrylate, dimethylolcyclopropane dimethacrylate, dimethylolcyclopentane dimethacrylate, dimethylolcyclohexane dimethacrylate, dimethylolcyclobutane dimethacrylate, bicyclobutane diacrylate, bicyclooctane diacrylate, bicyclononane diacrylate, bicycloundecane diacrylate, dimethylolbicyclobutane diacrylate, dimethylolbicyclooctane diacrylate, dimethylolbicyclononane diacrylate, dimethylolbicycloundecane diacrylate, bicyclobutane dimethacrylate, bicyclooctane dimethacrylate, bicyclononane dimethacrylate, bicycloundecane dimethacrylate, dimethylolbicyclobutane dimethacrylate, dimethylolbicyclooctane dimethacrylate, dimethylolbicyclononane dimethacrylate, dimethylolbicycloundecane dimethacrylate, tricycloheptane diacrylate, tricyclodecane diacrylate, tricyclododecane diacrylate, tricycloundecane diacrylate, tricyclotetradecane diacrylate, tricyclodecanetridecane diacrylate, dimethyloltricycloheptane diacrylate, dimethyloltricyclodecane diacrylate, dimethyloltricyclododecane diacrylate, dimethyloltricycloundecane diacrylate, dimethyloltricyclotetradecane diacrylate, dimethyloltricyclodecanetridecane diacrylate, tricycloheptane dimethacrylate, tricyclodecane dimethacrylate, tricyclododecane dimethacrylate, tricycloundecane dimethacrylate, tricyclotetradecane dimethacrylate, tricyclodecanetridecane dimethacrylate, dimethyloltricycloheptane dimethacrylate, dimethyloltricyclodecane dimethacrylate, dimethyloltricyclododecane dimethacrylate, dimethyloltricycloundecane dimethacrylate, dimethyloltricyclotetradecane dimethacrylate, dimethyloltricyclodecanetridecane dimethacrylate, spirooctane diacrylate, spiroheptane diacrylate, spirodecane diacrylate, cyclopentanespirocyclobutane diacrylate, cyclohexanespirocycopentane diacrylate, spirobicyclohexane diacrylate, dispiroheptadecane diacrylate, dimethylolspirooctane diacrylate, dimethylolspiroheptane diacrylate, dimethylolspirodecane diacrylate, dimethylolcyclopentanespirocyclobutane diacrylate, dimethylolcyclohexanespirocyclopentane diacrylate, dimethylolspirobicyclohexane diacrylate, dimethyloldispiroheptanedecane diacrylate, spirooctane dimethacrylate, spiroheptane dimethacrylate, spirodecane dimethacrylate, cyclopentanespirocyclobutane dimethacrylate, cyclohexanespirocyclopentane dimethacrylate, spirobicyclohexane dimethacrylate, dispiroheptadecane dimethacrylate, dimethylolspirooctane dimethacrylate, dimethylolspiroheptane dimethacrylate, dimethylolspirodecane dimethacrylate, dimethylolcyclopentanespirocyclobutane dimethacrylate, dimethylolcyclohexanespirocyclopentane dimethacrylate, dimethylolspirobicyclohexane dimethacrylate, dimethyloldispiroheptadecane dimethacrylate. Preferred compounds are dimethyloltricyclodecane diacrylate, dimethylolbicyclooctane diacrylate, and dimethylolspirooctane diacrylate. Dimethyloltricyclodecane diacrylate, which is of particular preference, is commercially available in the form of KAYARAD R-684, made by Nippon Kayaku Co., Ltd., Light Acrylate DCP-A, made by Kyoeisha Chemical Co., Ltd., and LUMICURE DCA-200, made by Dainippon Ink And Chemicals, Incorporated.

Other radiation-curing compounds may be employed in the coating liquid for the undercoating layer in addition to the radiation-curing resin. Examples of the compounds that are suitable for use together with the radiation curing resin are monofunctional acrylate compounds and methacrylate compounds. These may be employed as reactive diluting agents. Reactive diluting agents function to adjust the physical properties of the undercoating layer and the curing reaction of the coating liquid for the undercoating layer. An example of the preferred structure of such a compound is, among the radiation-curing resins suitable for use in the present invention that are given above, monofunctional group acrylate compounds having just one radiation-curing functional group per molecule. Specific examples are cyclohexyl (meth)acrylate, isobornyl (meth)acrylate, and tetrahydrofurfuryl (meth)acrylate. Here, the term (meth)acrylate is used to include both methacrylate and acrylate. The proportion of the above compound is desirably from 10 to 100 weight percent of the radiation-curing resin.

The coating liquid for the undercoating layer may be prepared by dissolving radiation-curing resin in a suitable solvent. Methyl ethyl ketone (MEK), methanol, ethanol, toluene or the like is desirably employed as a solvent. The quantity of solvent employed may be from 0 to 500 weight parts per 100 weight parts of radiation-curing resin.

The above-described coating liquid for the undercoating layer is applied to a nonmagnetic support, dried, and cured by exposure to radiation. The glass transition temperature Tg following curing is preferably from 80 to 150° C., more preferably 100 to 130° C. When the Tg is equal to or higher than 80° C., viscosity-induced defects do not occur during the coating step. When the Tg is equal to or less than 150° C., high-strength coatings can be obtained.

The radiation that is employed in the present invention can be an electron beam or ultraviolet radiation. When employing ultraviolet radiation, a photopolymerization initiator is added to the coating liquid for the undercoating layer. Curing with an electron beam is preferred because a polymerization initiator is unnecessary and transmittance depth is considerable. A scanning, double-scanning, or curtain beam type electron beam accelerator may be employed. The curtain beam type is preferred because high output can be achieved at relatively low cost. As regards electron beam characteristics, the accelerating voltage normally ranges from 30 to 1000 kV, preferably from 50 to 300 kV. The absorbed dose normally ranges from 0.5 to 20 Mrad, preferably from 2 to 10 Mrad. At an acceleration voltage equal to or higher than 30 kV, an adequate energy transmittance can be obtained, and at equal to or less than 1000 kV, the efficiency of energy employed in polymerization increases, which is economical. The atmosphere in which the electron beam is radiated is desirably reduced to an oxygen concentration of 200 ppm or less by means of a nitrogen purge. When the oxygen concentration is high, crosslinking and the curing reaction may be blocked near the surface.

A mercury lamp can be employed as the ultraviolet radiation source. A mercury lamp providing 20 to 240 W/cm can be employed at a speed of 0.3 m/min to 20 m/min. Generally, a distance between the base and the lamp of 1 to 30 cm is preferred. A photoradical polymerization initiator can be employed as a photopolymerization initiator in ultraviolet radiation curing. Details of photoradical polymerization initiators are, for example, described in “New Polymer Experimentology, Vol. 2, Chapter 6, Light and Radiation Polymerization” (Kyoritsu Publishing, released in 1995, ed. by the Polymer Society). Specific examples are: acetophenone, benzophenone, anthraquinone, benzoinethylether, benzyl methyl ketal, benzyl ethyl ketal, benzoinisobutylketone, hydroxydimethylphenylketone, 1-hydroxycyclohexylphenylketone, and 2-2-diethoxyacetophenone. The mixing ratio of the photoradical polymerization initiator normally ranges from 0.5 to 20 weight parts, preferably from 2 to 15 weight parts, and more preferably from 3 to 10 weight parts per 100 weight parts of the radiation-curing resin. Known radiation curing devices and conditions, such as those described in “UV·EB Curing Techniques” (published by Sogo Technical Center, K.K.) and “Application Techniques for Low-Energy Electron Beam Irradiation” (2000, published by CMC K.K.) may be employed.

In the magnetic recording medium of the present invention, the thickness of the undercoating layer preferably ranges from 0.1 to 1.0 μm, more preferably from 0.2 to 0.8 μm. When the thickness of the undercoating layer is equal to or greater than 0.1 μm, roughness of the support can be effectively masked. When the undercoating layer is excessively thick, the coating tends not to dry and there is a risk of viscosity-induced defects. Thus, in the present invention, the undercoating layer is desirably equal to or less than 1.0 μm in thickness.

In the present invention, forming a magnetic layer on a smooth undercoating layer that masks protrusions and roughness on the support yields a magnetic recording medium of high surface smoothness. Variation in thickness can be used as an indicator of the surface smoothness of the undercoating layer. The variation in thickness is a value that is calculated as the “standard deviation σ/layer thickness”. The variation in thickness can be calculated based on observation of ultrathin sections of magnetic tape (for example, 10 μm in length) at, for example, a magnification of 50,000 under a transmission electron microscope (TEM). In the present invention, the variation in thickness of the undercoating layer is preferably equal to or less than 50 percent, more preferably from 0 to 25 percent. When the variation in thickness of the undercoating layer is equal to or less than 50 percent, protrusions and roughness on the support are masked and a magnetic layer of high surface smoothness is formed. In the present invention, a coating liquid for the undercoating layer is applied to and dried on a nonmagnetic support and, by means of the leveling effect, rough protrusions on the surface of the nonmagnetic support are masked, permitting the formation of an undercoating layer of high smoothness with a variation in thickness equal to or less than 50 percent.

[Magnetic Layer]

In the present invention, a magnetic layer is applied over the aforementioned undercoating layer to form a magnetic layer of high surface smoothness. In the magnetic recording medium of the present invention, the surface roughness Ra of the magnetic layer is preferably equal to or less than 2 nm, more preferably from 1.5 to 1.8 nm, and further preferably, from 1.0 to 1.5 nm. Here, the “surface roughness Ra” refers to the surface roughness as measured by the 3D-MIRAU method. When the surface roughness Ra of the magnetic layer is equal to or less than 2 nm, spacing loss can be reduced in systems in which a short recording wavelength is employed in conjunction with high densification.

In the magnetic recording medium of the present invention, the thickness of the magnetic layer preferably ranges from 30 to 200 nm, more preferably from 30 to 100 nm, and further preferably, from 30 to 80 nm. When the thickness of the magnetic layer is equal to or greater than 30 nm, it is possible to form a uniform coating. A thickness of the magnetic layer of equal to or less than 200 nm is desirable in that no drop in output occurs due to thickness loss.

As set forth above, in the present invention, it is possible to form a magnetic layer of good surface smoothness by providing a magnetic layer on an undercoating layer comprising a radiation-curing resin as a main component. However, the greater the smoothness of the magnetic layer, the greater the deterioration of coating durability. In the present invention, a diamond powder is incorporated into the magnetic layer to ensure coating durability. This yields a magnetic recording medium affording both excellent surface smoothness and coating durability.

The diamond powder contributes more to coating durability when added in small amounts than other abrasives (alumina, zirconia, and the like) commonly employed in the magnetic layer. Further, the addition of diamond powder also has the effect of sharply reducing the negative effects of magnetic powder aggregates and the other defects of the magnetic layer, thus effectively and sharply reducing noise. Output also increases, making it possible to achieve a magnetic recording medium having both an excellent S/N ratio and durability, heretofore unachievable.

In the present invention, where the thickness of the magnetic layer is denoted as d (nm), the mean particle diameter of the diamond powder employed in the magnetic layer preferably falls within a range of 0.7 d to 1.3 d (nm), more preferably 0.8 d to 1.2 d (nm). Specifically, the mean particle diameter of the diamond powder preferably ranges from 50 to 150 nm, more preferably from 50 to 100 nm. In the present invention, the maximum diameter of each diamond particle is adopted as the particle diameter and the mean particle diameter is the average value of the values measured for 500 particles selected randomly by electron microscope. When the mean particle diameter of the diamond powder is equal to or greater than 7 d (nm), for a magnetic layer thickness of d (nm), the quantity of diamond powders protruding on the surface is suitable and coating strength can be ensured. When the mean particle diameter of the diamond powders is excessively high relative to the thickness of the magnetic layer, the quantity of diamond powders protruding on the surface becomes excessive and head abrasion becomes marked. In the present invention, the mean particle diameter of the diamond powder is desirably equal to or less than 1.3 d (nm), where d (nm) denotes the thickness of the magnetic layer.

The quantity of diamond powder added preferably ranges from 0.01 to 5 weight percent, more preferably 0.03 to 3.00 weight percent, of the ferromagnetic powder. When the quantity of diamond powder added falls within the stated range, high coating durability can be ensured. However, since the addition of an excessive quantity of diamond powder runs the risk of increasing noise, the quantity of diamond powder added is desirably equal to or less than 5 weight percent of the ferromagnetic powder. In the present invention, the quantity and mean particle diameter of the diamond powder added are desirably selected from within the above-stated ranges in a manner suited to the magnetic recording and reproducing device.

The particle size distribution of the diamond powder is desirably as follows: the number of particles with a diameter of 200 percent or more that of the mean particle diameter is equal to or less than 5 percent of the total number of diamond powders; and the number of particles with a diameter of 50 percent or less that of the mean particle diameter is equal to or less than 20 percent of the total number of diamond powders. The maximum particle diameter of the diamond powder employed in the present invention is normally 3.00 μm, and preferably about 2.00 μm; the minimum diameter is normally 0.01 μm and preferably about 0.02 μm.

In the course of measuring the above particle diameters, the number of diamond powders of a given diameter can be tallied and the particle size distribution calculated based on the mean particle diameter. The particle size distribution of the diamond powder also affects durability and noise. That is, the presence of a large number of particles of excessive diameter increases noise and runs the risk of scratching the head. When a large number of minute particles is present, there is a risk of an inadequate abrasive effect. When the distribution of particle size is extremely narrow, the cost of diamonds becomes quite high. Thus, it is also advantageous in terms of cost for the particle size distribution to fall within the above-stated range. When microparticulate diamond particles having high hardness and sharp particle size distribution are employed, it is possible to employ a smaller quantity than would be required with conventional abrasives to achieve the same effect, which is advantageous from the perspective of noise.

Further, in the present invention, conventionally employed abrasives such as alumina and SiC may be used in addition to diamond powders in the magnetic layer. The quantity thereof is desirably equal to or less than 500 weight percent of the diamond powders. The use of a small quantity of diamond powders alone is advantageous for durability and the S/N ratio, but from the perspective of cost and the like, abrasives other than diamond powders may be added, such as alumina and SiC. In such cases, due to the addition of diamond powders, the quantity of additional abrasives incorporated may be greatly reduced relative to the quantity required to ensure durability with alumina alone, for example, which is highly desirable from the perspectives of ensuring durability and reducing noise.

Either natural diamonds or artificial diamonds may be employed in the magnetic layer. However, natural diamonds are expensive, so artificial diamonds are normally employed. The diamonds may be manufactured at high temperature and under high pressure from graphite and Fe, Co, Ni, or the like; by the static synthesis method in which graphite or furan resin carbon are reacted at high temperature and under high pressure; by dynamic synthesis methods; and by gas-phase synthesis methods. In the present invention, any method can be employed for the manufacture of diamond. Industrially, it is possible to re-use diamonds that have been employed in cutting and polishing by sorting out impurities and cleaning the diamonds. In the present invention, the particle size distribution of the diamond particles desirably falls within the above-stated range. The diamond particles can be graded by subjecting a dispersion to centrifugal force, using a special mesh filter, or the like.

As mentioned above, diamonds can be employed together with other abrasives. Known materials, primarily with a Mohs' hardness equal to or higher than 6, such as alumina abrasives, for example, α-alumina having an α-conversion rate equal to or higher than 90 percent, β-alumina, silicon carbide, chromium oxide, cerium oxide, α-iron oxide, corundum, silicon nitride, titanium carbide, titanium oxide, silicon dioxide, and boron nitride, may be used singly or in combination as abrasives employed together with diamond. Further, a composite comprising two or more of these abrasives (an abrasive obtained by surface-treating one abrasive with another) may also be used. Although these abrasives may contain compounds and elements other than the main component or element in some cases, there is no change in effect so long as the main component constitutes equal to or higher than 90 percent. The particle size of these abrasives preferably ranges from 0.01 to 2 μm, a narrow particle size distribution being particularly desirable for improving electromagnetic characteristics. As needed to improve durability, abrasives of differing particle size may be combined or the same effect may be achieved by broadening the particle diameter distribution even with a single abrasive. A tap density of 0.3 to 2 g/cc, a moisture content of 0.1 to 5 percent, a pH of 2 to 11, and a specific surface area of 1 to 30 m²/g are desirable. The abrasive employed in the present invention may be any of acicular, spherical, or cubic in shape, but shapes that are partially angular have good abrasion properties and are thus preferred. Specific examples are: AKP-12, AKP-15, AKP-20, AKP-30, AKP-50, HIT-20, HIT-30, HIT-55, HIT-60, HIT-70, HIT-80 and HIT-100 from Sumitomo Chemical Co., Ltd.; ERC-DBM, HP-DBM, and HPS-DBM from Reynolds Co.; WA10000 from Fujimi Abrasives Co.; UB20 from Kamimura Kogyo Co., Ltd.; G-5, Chromex U2, and Chromex U1 from Nippon Chemical Industrial Co., Ltd.; TF100 and TF-140 from Toda Kogyo Corp.; Beta Random Ultrafine from Ibidene Co.; and B-3 from Showa Mining Co., Ltd.

The ferromagnetic powder comprised in the magnetic layer can be a ferromagnetic metal powder having a mean major axis length ranging from 20 to 70 nm or a hexagonal ferrite powder having a mean plate diameter ranging from 10 to 35 nm.

Preferred ferromagnetic metal powders are those having a principal component in the form of α-Fe. In addition to prescribed atoms, the ferromagnetic metal powder may comprise the following atoms: Al, Si, Ca, Mg, Ti, Cr, Cu, Y, Sn, Sb, Ba, W, La, Ce, Pr, Nd, P, Co, Mn, Zn, Ni, Sr, and B. The incorporation of at least one from among Al, Ca, Mg, Y, Ba, La, Nd, Sm, Co, and Ni in addition to α-Fe is desirable. The formation of an alloy of Co and Fe is particularly desirable because saturation magnetization increases and there is improvement in demagnetization. The content of Co relative to Fe desirably ranges from 1 to 40 atomic percent, preferably from 15 to 35 atomic percent, and more preferably from 20 to 35 atomic percent. The content of rare earth elements such as Y desirably ranges from 1.5 to 12 atomic percent, preferably from 3 to 10 atomic percent, and more preferably from 4 to 9 atomic percent. The content of Al desirably ranges from 1.5 to 12 atomic percent, preferably from 3 to 10 atomic percent, and more preferably from 4 to 9 atomic percent. Rare earth elements including Y and Al can prevent sintering, and sintering can be effectively prevented by jointly employed them. These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

A small quantity of hydroxide or oxide may be incorporated into the ferromagnetic metal power. Ferromagnetic metal powder obtained by known manufacturing methods may be employed. Examples of methods are given below: the method of obtaining Fe or Fe—Co particles by reducing with a reducing gas a hydrous iron oxide or iron oxide that has been treated to prevent sintering; the method of reducing a complex organic acid salt (primarily oxalates) by means of a reducing gas such as hydrogen or the like; the method of thermally decomposing a metal carbonyl compound; the method of reduction by adding a reducing agent such as sodium boron hydride, hypophosphite, or hydrazine to an aqueous solution of a ferromagnetic metal; and the method of obtaining powders by vaporizing a metal in an inert gas at low pressure. The ferromagnetic metal powders thus obtained can be subjected to known slow oxidation treatments. Methods in which hydrous iron oxide or iron oxide is reduced with a reducing gas such as hydrogen and the partial pressures of the oxygen-comprising gas and inert gas, the temperature, and the time are controlled to form an oxide film on the surface result in little demagnetization are preferred as slow oxidation treatments.

The specific surface area by BET method (S_{BET}) of the ferromagnetic metal powder preferably ranges from 40 to 80 m²/g, more preferably from 45 to 70 m²/g. At equal to or greater than 40 m²/g, noise decreases, and at equal to or less than 80 m²/g, a smooth surface can be obtained thus both are preferred. The crystallite size of the ferromagnetic metal powder preferably ranges from 80 to 180 Å, more preferably from 100 to 170 Å, and further preferably from 110 to 165 Å. The mean major axis length of the ferromagnetic metal powder preferably ranges from 20 to 70 nm, more preferably from 30 to 50 nm. When the mean major axis length of the ferromagnetic metal powder is equal to or greater than 20 nm, magnetization loss due to thermal fluctuation is not occurred. At equal to or less than 70 nm, error rate deterioration due to noise increase can be avoided. The average acicular ratio {average of (major axis length/minor axis length)} of the ferromagnetic metal powder preferably ranges from 3 to 15 and more preferably from 3 to 10. The saturation magnetization (σs) of the ferromagnetic metal powder preferably ranges from 90 to 170 A·m²/kg, more preferably from 100 to 160 A·m²/kg, and further preferably from 110 to 160 A·m²/kg. The coercivity of the ferromagnetic metal powder preferably ranges from 1,700 to 3,500 Oe, approximately 135 to 279 kA/m, more preferably from 1,800 to 3,000 Oe, approximately 142 to 239 kA/m.

The moisture content of the ferromagnetic metal powder preferably ranges from 0.1 to 2 weight percent; the moisture content of the ferromagnetic metal powder is desirably optimized by means of the type of binder. The pH of the ferromagnetic metal powder is desirably optimized in combination with the binder employed; the range is normally pH 6 to 12, preferably pH 7 to 11. The stearic acid (SA) adsorption capacity of the ferromagnetic metal powder (the scale of basic points on the surface) is usually 1 to 15 μmol/m², preferably from 2 to 10 μmol/m², and more preferably from 3 to 8 μmol/m². When employing a ferromagnetic metal powder with a high stearic acid adsorption capacity, surface modification with an organic compound adsorbing strongly onto the surface is desirable to create a magnetic recording medium. Inorganic ions of soluble Na, Ca, Fe, Ni, Sr, NH₄, SO₄, Cl, NO₂, NO₃ and the like are sometimes incorporated into the ferromagnetic metal powder. It is basically desirable that these not be present, but characteristics are not particularly affected when the quantity thereof is approximately equal to or less than 300 ppm. Further, the ferromagnetic metal powder employed in the present invention desirably has few pores. The content of pores is preferably equal to or less than 20 volume percent, more preferably equal to or less than 5 volume percent. So long as the above-stated particle size and magnetic characteristics are satisfied, the particles may be acicular, rice-particle shaped, or spindle-shaped. The switching field distribution (SFD) of the ferromagnetic metal powder itself is desirably low. If the SFD of the magnetic recording medium is low, magnetization reversal is sharp and peak shifts are small, which are suited to high density digital magnetic recording. It is preferable to narrow the Hc distribution of the ferromagnetic metal powder. A low Hc distribution is achieved, for example, by improving the goethite particle size distribution in the ferromagnetic metal powder; by employing monodispersed α-Fe₂O₃; by preventing sintering between particles.

Examples of hexagonal ferrite powders suitable for use in the present invention are barium ferrite, strontium ferrite, lead ferrite, calcium ferrite, and various substitution products thereof, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Nb, Sn, Ti, V, Cr, Cu, Y, Mo, Rh, Pd, Ag, Sn, Sb, Te, W, Re, Au, Bi, La, Ce, Pr, Nd, P, Co, Mn, Zn, Ni, B, Ge, Nb, and the like. Compounds to which elements such as Co—Zn, Co—Ti, Co—Ti—Zr, Co—Ti—Zn, Ni—Ti—Zn, Nb—Zn—Co, Sn—Zn—Co, Sn—Co—Ti and Nb—Zn have been added may generally also be employed. They may comprise specific impurities depending on the starting materials and manufacturing methods employed. The mean plate diameter of the hexagonal ferrite powder preferably ranges from 10 to 35 nm, more preferably 20 to 25 nm. Particularly when employing a magnetoresistive head (MR head) in reproduction to increase a track density, a plate diameter equal to or less than 35 nm is desirable to reduce noise. A mean plate diameter equal to or higher than 10 nm yields stable magnetization without the effects of thermal fluctuation. A mean plate diameter equal to or less than 35 nm permits low noise and is suited to the high-density magnetic recording. The mean plate thickness of the hexagonal ferrite powder preferably ranges from 4 to 15 nm. At equal to or greater than 4 nm, stable production is possible and at equal to or less than 15 nm, adequate orientation can be obtained.

The plate ratio (plate diameter/plate thickness) of the hexagonal ferrite powder preferably ranges from 1 to 15, more preferably from 1 to 7. Low plate ratio is preferable to achieve high filling property, but some times adequate orientation is not achieved. When the plate ratio is equal to or less than 15, noise can be reduced due to stacking between particles. The specific surface area by BET method of the hexagonal ferrite particles having such particle sizes ranges from 30 to 200 m²/g, almost corresponding to an arithmetic value from the particle plate diameter and the plate thickness. Narrow distributions of particle plate diameter and thickness are normally good. Although difficult to render in number form, about 500 particles can be randomly measured in a TEM photograph of particles to make a comparison. This distribution is often not a normal distribution. However, when expressed as the standard deviation to the average particle size, σ/average particle size=0.1 to 1.5. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. By a vitrified crystallization method, uniform powders can be produced by performing repeated thermal treatments to separate nuclear generation and growth.

A coercivity (Hc) of the hexagonal ferrite powder of about 50 to 5,000 Oe, approximately 40 to 398 kA/m, can normally be achieved. A high coercivity Hc is advantageous for high-density recording, but this is limited by the capacity of the recording head. Coercivity (Hc) can be controlled by particle size (plate diameter and plate thickness), the types and quantities of elements contained, substitution sites of the element, the particle producing reaction conditions, and the like. The saturation magnetization (σs) can be 30 to 70 A·m²/kg. The saturation magnetization (σs) tends to decrease with decreasing particle size. Known methods of improving saturation magnetization (σs) are lowering a crystallization temperature, shortening a thermal treatment time, increasing the quantity of compounds added, increasing the level of surface treatment, and the like. It is also possible to employ W-type hexagonal ferrite powder. When dispersing hexagonal ferrite powder, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added may ranges from 0.1 to 10 weight percent relative to the hexagonal ferrite powder. The pH of the hexagonal ferrite powder is also important to dispersion. A pH of 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.1 to 2.0 weight percent.

Methods of manufacturing hexagonal ferrite include: (1) a vitrified crystallization method in which a metal oxide substituted with barium carbonate, iron oxide, and iron, and a glass-forming substance in the form of boron oxide or the like are mixed in proportions designed to yield a desired ferrite composition, melted, and quenched to obtain an amorphous product, subjected to a heat treatment again, washed, and pulverized to obtain barium ferrite crystal powder; (2) a hydrothermal reaction method in which a barium ferrite composition metal salt solution is neutralized with an alkali, the by-products are removed, the solution is liquid-phase heated at equal to or higher than 100° C., and the product is washed, dried, and pulverized to obtain barium ferrite crystal powder; and (3) a coprecipitation method in which a barium ferrite composition metal salt solution is neutralized with an alkali, the by-products are removed, and the solution is dried, processed at equal to or less than 1,100° C., and pulverized to obtain barium ferrite crystal powder. Any methods may be employed in the present invention.

Examples of types of carbon black that are suitable for use in the magnetic layer are: furnace black for rubber, thermal for rubber, black for coloring, conductive carbon black and acetylene black. A specific surface area of 5 to 500 m²/g, a DBP oil absorption capacity of 10 to 400 ml/100 g, an average particle size of 5 to 300 nm, a pH of 2 to 10, a moisture content of 0.1 to 10 weight percent, and a tap density of 0.1 to 1 g/cc are respectively desirable. Specific examples of types of carbon black employed in the magnetic layer are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. The quantity of carbon black comprised in the magnetic layer preferably ranges from 0.1 to 30 weight percent of the ferromagnetic powder. In the magnetic layer, carbon black works to prevent static, reduce the coefficient of friction, impart light-blocking properties, enhance film strength, and the like; the properties vary with the type of carbon black employed. Accordingly, it is desirable that the type and quantity of carbon black employed are determined based on the objective and the various characteristics stated above, such as particle size, oil absorption capacity, electrical conductivity, and pH. For example, Carbon Black Handbook compiled by the Carbon Black Association may be consulted for types of carbon black suitable for use in the present invention.

Conventionally known thermoplastic resins, thermosetting resins, reactive resins and mixtures thereof may be employed as binders used in the magnetic layer. The thermoplastic resins suitable for use have a glass transition temperature of −100 to 150° C., a number average molecular weight of 1,000 to 200,000, preferably from 10,000 to 100,000, and have a degree of polymerization of about 50 to 1,000. Examples are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins in individual layers. Examples and details of such resins are described in Japanese Unexamined Patent Publication (KOKAI) Showa No. 62-256219. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate.

Known structures of polyurethane resin can be employed, such as polyester polyurethane, polyether polyurethane, polyether polyester polyurethane, polycarbonate polyurethane, polyester polycarbonate polyurethane, and polycaprolactone polyurethane. To obtain better dispersibility and durability in all of the binders set forth above, it is desirable to introduce by copolymerization or addition reaction one or more polar groups selected from among —COOM, —SO₃M, —OSO₃M, —P═O(OM)₂, —O—P═O(OM)₂ (where M denotes a hydrogen atom or an alkali metal base), —OH, —NR₂, —N⁺R₃ (where R denotes a hydrocarbon group), epoxy groups, —SH, and —CN. The quantity of the polar group is preferably from 10⁻¹ to 10⁻⁸ mol/g, more preferably from 10⁻² to 10⁻⁶ mol/g.

Specific examples of these binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The binder employed in the magnetic layer is suitably employed in a range of 5 to 50 weight percent, preferably from 10 to 30 weight percent with respect to the ferromagnetic powder. Vinyl chloride resin, polyurethane resin, and polyisocyanate are preferably combined within the ranges of: 5 to 30 weight percent for vinyl chloride resin, when employed; 2 to 20 weight percent for polyurethane resin, when employed; and 2 to 20 weight percent for polyisocyanate. However, when a small amount of dechlorination causes head corrosion, it is also possible to employ polyurethane alone, or employ polyurethane and isocyanate alone. In the present invention, when polyurethane is employed, a glass transition temperature of −50 to 150° C., preferably 0 to 100° C., an elongation at break of 100 to 2,000 percent, a stress at break of 0.05 to 10 kg/mm², approximately 0.49 to 98 MPa, and a yield point of 0.05 to 10 kg/mm², approximately 0.49 to 98 MPa, are desirable.

Examples of polyisocyanates suitable for use in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used singly or in combinations of two or more in all layers by exploiting differences in curing reactivity.

Substances having lubricating effects, antistatic effects, dispersive effects, plasticizing effects, or the like may be employed as additives in the magnetic layer in the present invention. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; α-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms (which may contain an unsaturated bond or be branched); monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.). These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent. Generally, the total quantity of lubricants may range from 0.1 to 50 weight percent, preferably 2 to 25 weight percent with respect to the ferromagnetic powder.

All or some of the additives used in the present invention may be added at any stage in the process of manufacturing the magnetic coating liquid. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits. Known organic solvents may be employed in the present invention. For example, the solvents described in Japanese Unexamined Patent Publication (KOKAI) Showa No. 6-68453 may be employed.

[Backcoat Layer]

In the magnetic recording medium of the present invention, a backcoat layer can be provided on the surface of the nonmagnetic support, opposite to the surface having the magnetic layer. In the backcoat layer, the principal filler employed can be microparticulate carbon black having excellent electrical conductivity. Two types of carbon black having different mean particle sizes can be incorporated, and, as needed, inorganic powder can be incorporated. For example, it is possible to incorporate an inorganic powder with a Mohs' hardness of 5 to 9. The inorganic powder is normally incorporated into the backcoat layer in a proportion of 0.5 to 150 weight parts, preferably 0.5 to 100 weight parts, per 100 weight parts of carbon black.

As mentioned above, the backcoat layer can comprise two types of carbon black having different mean particle sizes. For example, microparticulate carbon black having a mean particle size ranging from 10 to 30 nm and coarse-granular carbon black having a mean particle size ranging from 50 to 500 nm, preferably 60 to 400 nm, can be employed. Generally, the addition of microparticulate carbon black as above achieves lowering the surface electrical resistivity and reducing the light transmittance of the backcoat layer. Since many magnetic recording devices use the light transmittance of the tape for the operating signal, in such cases, it is particularly effective to add microparticulate carbon black. Microparticulate carbon black generally has good lubricant retentivity, and when employed in combination with a lubricant, contributes to reducing the coefficient of friction.

Coarse-granular carbon black with a particle size of 50 to 500 nm, preferably 60 to 400 nm, functions as a solid lubricant, forming minute protrusions on the surface of the backcoat layer, reducing the contact surface area, and contributing to reducing the coefficient of friction.

Specific examples of microparticulate carbon black products are given below. The particle size of each type of carbon black is also given:
Raven 2000B (18 nm), Raven 1500B (17 nm) (both of which are manufactured by Columbia Carbon Co., Ltd.), BP800 (17 nm) (Cabot Corporation), PRINTEX 90 (14 nm), PRINTEX 95 (15 nm), PRINTEX 85 (16 nm), and PRINTEX 75 (17 nm) (manufactured by Degusa Co.), and #3950 (16 nm) (manufactured by Mitsubishi Chemical Corp.).

Specific examples of coarse-granular carbon black products are: Thermal Black (270 nm) (manufactured by Cancarb limited.) and RAVEN MTP (275 nm) (manufactured by Columbia Carbon Co., Ltd.). Carbon black having a mean particle size of 50 to 500 nm can be selected from black for rubber and carbon black for coloring.

In the present invention, the ratio of microparticulate carbon black to coarse-granular carbon black incorporated in the backcoat layer is preferably (by weight), former:latter, from 98:2 to 75:25, more preferably from 95:5 to 85:15.

Examples of inorganic powders that can be added to the backcoat layer are those having a mean particle size of 80 to 250 nm and a Mohs' hardness of 5 to 9. Specific examples of inorganic powders are α-iron oxide, α-alumina, chromium oxide (Cr₂O₃), and TiO₂. Of these, α-iron oxide and α-alumina are preferred.

In addition to the above-stated components, optional components in the form of dispersants and lubricants can be added to the backcoat layer. Examples of dispersants are caprylic acid, capric acid, lauric acid, myristic acid, palmitic acid, stearic acid, behenic acid, oleic acid, elaidic acid, linolic acid, linolenic acid, stearolic acid and other fatty acids (RCOOH, where R denotes an alkenyl group or an alkyl group having from 11 to 17 carbon atoms) having from 12 to 18 carbon atoms; metal soaps comprised of one of the above fatty acids and an alkali metal or alkaline earth metal; fluorine-containing compounds in the form of esters of one of the above-described fatty acids; amides of the above-described fatty acids; polyalkyleneoxide alkyl phosphoric esters; lecithin; trialkylpolyolefinoxy quaternary ammonium salts (where the alkyl comprises from 1 to 5 carbon atoms and the olefin is ethylene, propylene, or the like); sulfuric esters; copper phthalocyanine; and precipitated barium sulfate. The dispersant can be added in a range of 0.5 to 20 weight parts per 100 weight parts of binder resin.

Examples of the binder incorporated into the backcoat layer are nitrocellulose resin, polyurethane resin, polyester resin, vinyl chloride resin, and phenoxy resin. The total quantity of the binder in the backcoat layer may be 0.3 to 0.7 of the total weight of the backcoat layer.

The backcoat layer may be provided by the usual methods on the opposite side of the nonmagnetic support from the side on which the magnetic layer is provided. That is, the individual components set forth above are dissolved in a suitable organic solvent, a dispersed coating liquid is prepared, and this coating liquid is applied and dried by the usual methods to form a backcoat layer on the nonmagnetic support. In the present invention, the surface roughness Ra of the backcoat layer, measured by the 3D-MIRAU method as the center-surface average roughness, is preferably from 2.0 to 15 nm, more preferably from 2.0 to 10 nm. Since the surface of the backcoat layer is transferred to the surface of the magnetic layer when the tape is wound, affecting reproduction output and affecting the coefficient of friction with the guide poles, the surface roughness of the backcoat layer is desirably adjusted to fall within the above-stated range. The surface roughness Ra can be adjusted by applying the backcoat layer and then, in the calendering surface processing step, adjusting the material, surface properties, pressure, and the like of the calender rolls. In the present invention, the thickness of the backcoat layer is preferably from 0.2 to 0.8 μm, more preferably from 0.2 to 0.7 μm.

[Layer Structure]

In the magnetic recording medium of the present invention, the thickness of the nonmagnetic support preferably ranges from 2.5 to 8 μm, and to increase the volume density, more preferably from 2.5 to 7.5 μm, further preferably from 3.0 to 7 μm.

In the magnetic recording medium of the present invention, the thickness of the magnetic layer, as stated above, preferably ranges from 30 to 200 nm. The magnetic layer may be divided into two or more layers of differing magnetic characteristics and a known multilayered magnetic layer configuration may be employed.

[Nonmagnetic Support]

Known films of the following may be employed as the nonmagnetic support in the present invention: polyethylene terephthalate, polyethylene naphthalate, other polyesters, polyolefins, cellulose triacetate, polycarbonate, polyamides, polyimides, polyamidoimides, polysulfones, aromatic polyamides, polybenzooxazoles, and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127 may be employed to vary the surface roughness of the magnetic surface and support surface. These supports may be subjected beforehand to corona discharge treatment, plasma treatment, adhesion enhancing treatment, heat treatment, dust removal, and the like.

In the present invention, the center surface average surface roughness (SRa) of the support as measured by the MIRAU method with a TOPO-3D made by WYKO is preferably equal to or less than 5.0 nm, more preferably equal to or less than 3.0 nm, further preferably equal to or less than 2.0 nm. Not only does such a support desirably have a low center surface average surface roughness, but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic powders such as acrylic-based one. The support desirably has a maximum height SRₘₐₓ equal to or less than 1 μm, a ten-point average roughness SR_{Z} equal to or less than 0.5 μm, a center surface peak height SR_{P} equal to or less than 0.5 μm, a center surface valley depth SR_{V} equal to or less than 0.5 μm, a center-surface surface area percentage SSr from of 10 percent to 90 percent, and an average wavelength S λₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 u m in size per 0.1 mm².

The F-5 value of the nonmagnetic support in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 980 to 19600 MPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

[Manufacturing Method]

The process for manufacturing coating liquids for each layer comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder and all or part of the binder (preferably equal to or higher than 30 weight percent of the entire quantity of binder) are kneaded in a range of 15 to 500 parts per 100 parts of the ferromagnetic powder. Details of the kneading process are described in Japanese Unexamined Patent Publication (KOKAI) Heisei Nos. 1-106338 and 1-79274. Further, glass beads may be employed to disperse the coating liquids, with a dispersing medium with a high specific gravity such as zirconia beads, titania beads, and steel beads being suitable for use. The particle diameter and fill ratio of these dispersing media are optimized for use. A known dispersing device may be employed. The ferromagnetic powder, abrasives and carbon black, that have different dispersion speeds, can be pre-dispersed separately and mixed, and if necessary, further dispersed finely to prepare a coating liquid.

The magnetic recording medium of the present invention may be formed by applying, drying, and curing with radiation a coating liquid for the undercoating layer on a nonmagnetic support, and then applying and drying a magnetic layer coating liquid thereover. As set forth above, in the present invention, surface roughness and protrusions on the nonmagnetic support can be masked with an undercoating layer to obtain a magnetic layer of good smoothness. Coating devices commonly employed to apply magnetic coating liquids, such as a gravure coating, roll coating, blade coating, or extrusion coating device, can be employed for coating a coating liquid for each layer. To avoid compromising the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968. In addition, the viscosity of the coating liquid preferably satisfies the numerical range specified in Japanese Unexamined Patent Publication (KOKAI) Heisei No. 3-8471.

Processing may be conducted with calender rolls in the form of heat-resistant plastic rolls such as epoxy, polyimide, polyamide, and polyimidoamide, or metal rolls. The processing temperature is preferably equal to or higher than 50° C., more preferably equal to or higher than 100° C. The linear pressure is preferably equal to or higher than 200 kg/cm, approximately 1960 N/cm, more preferably equal to or higher than 300 kg/cm, approximately 2940 N/cm.

The coefficient of friction of the magnetic recording medium of the present invention relative to the head is preferably equal to or less than 0.5 and more preferably equal to or less than 0.3 at temperatures ranging from −10° C. to 40° C. and humidity ranging from 0 percent to 95 percent, and the charge potential preferably ranges from ˜500 V to +500 V The modulus of elasticity at 0.5 percent extension of the magnetic layer preferably ranges from 100 to 2,000 kg/mm², approximately 980 to 19600 MPa, in each in-plane direction. The breaking strength preferably ranges from 10 to 70 kg/mm², approximately 98 to 686 MPa. The modulus of elasticity of the magnetic recording medium preferably ranges from 100 to 1,500 kg/mm², approximately 980 to 14700 MPa, in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent. The glass transition temperature (i.e., the temperature at which the loss elastic modulus of dynamic viscoelasticity peaks as measured at 110 Hz) of the magnetic layer is preferably 50 to 120° C. The loss elastic modulus preferably falls within a range of 1×10³ to 8×10⁴ N/cm² and the loss tangent is preferably equal to or less than 0.2. Adhesion failure tends to occur when the loss tangent becomes excessively large. These thermal characteristics and mechanical characteristics are desirably nearly identical, varying by 10 percent or less, in each in-plane direction of the medium. The residual solvent in the magnetic layer is preferably equal to or less than 100 mg/m² and more preferably equal to or less than 10 mg/m². The void ratio in the magnetic layer is preferably equal to or less than 30 volume percent, more preferably equal to or less than 20 volume percent. Although a low void ratio is preferable for attaining high output, there are some cases in which it is better to ensure a certain level based on the object.

The maximum height Rₘₐₓ of the magnetic layer is preferably equal to or less than 0.5 μm, the ten-point average surface roughness Rz is preferably equal to or less than 0.3 μm, the center surface peak height Rp is preferably equal to or less than 0.3 μm, the center surface valley depth Rv is preferably equal to or less than 0.3 μm, the center-surface surface area percentage Sr is preferably from 20 to 80 percent, and the average wavelength λ a is preferably from 5 to 300 μm. On the surface of the magnetic layer, it is possible to freely control the number of surface protrusions of 0.01 to 1 μm in size within a range from 0 to 2,000 per 0.1 mm² to optimize electromagnetic characteristics and the coefficient of friction. These can be readily achieved by controlling surface properties through the filler used in the support, by controlling the particle diameter and quantity of the powder added to the magnetic layer, and by controlling the roll surface configuration in calendar processing. Curling is preferably controlled to within ±3 mm.

The magnetic recording medium of the present invention is particularly suited to use in linear magnetic recording and reproducing devices. In linear systems, the speed of the medium relative to the head is lower than in helical scan systems and the tape does not wind around the head, so the spacing between the medium and the head becomes marked. Thus, in linear systems, it is both necessary to render the medium as smooth as possible and ensure durability. As set forth above, the magnetic recording medium of the present invention affords both good surface smoothness and coating durability. Thus, it is particularly suited to linear systems requiring both smoothness and durability.

### EMBODIMENTS

The specific examples of the present invention and comparative examples will be described below. However, the present invention is not limited to the examples. Further, the “parts” given in the embodiments are weight parts unless specifically stated otherwise.

### Embodiment 1

The various components, set forth below, of the magnetic layer coating liquid and backcoat layer coating liquid were kneaded in an open kneader and dispersed in a sandmill. The dispersions obtained were filtered with a filter having a mean pore diameter of 1 μm to prepare a magnetic layer coating liquid and a backcoat layer coating liquid.

Magnetic Layer Coating Liquid

| | | |
|---|---|---|
| Barium ferrite magnetic powder | 100 | parts |
| Hc: 199 kA/m (2500 Oe) | | |
| Mean plate diameter: 30 nm | | |
| Sulfonic acid group-containing | 15 | parts |
| polyurethane resin | | |
| Carbon black | 0.5 | part |
| Mean particle diameter: 20 nm | | |
| Diamond powder | 2 | parts |
| Cyclohexanone | 150 | parts |
| Methyl ethyl ketone | 150 | parts |
| Butyl stearate | 0.5 | part |
| Stearic acid | 1 | part |

Backcoat Layer Coating Liquid

| | | |
|---|---|---|
| Inorganic nonmagnetic powder, α-iron oxide | 80 | parts |
| Mean major axis length: 0.15 μm | | |
| Mean acicular ratio: 7 | | |
| Specific surface area by BET method: 52 m²/g | | |
| Carbon black | 20 | parts |
| Mean particle diameter: 20 nm | | |
| Carbon black | 3 | parts |
| Mean particle diameter: 100 nm | | |
| Vinyl chloride copolymer | 13 | parts |
| Sulfonic acid group-containing polyurethane resin | 6 | parts |
| Phenylphosphonic acid | 3 | parts |
| Cyclohexanone | 140 | parts |
| Methyl ethyl ketone | 170 | parts |
| Stearic acid | 3 | parts |

Coating Liquid for Undercoating Layer

The following components were mixed and stirred to prepare a coating liquid for undercoating layer.

| | |
|---|---|
| Dimethyloltricyclodecane diacrylate | 100 parts |
| Methyl ethyl ketone | 100 parts |

The coating liquid for the undercoating layer was applied in a quantity calculated to yield a thickness of 0.5 μm on a PET support of 6 μm in thickness with a centerline average surface roughness of 3 nm and cured by exposure to a 6 Mrad absorbed dose with an electron beam irradiation device. The magnetic layer coating liquid was applied thereover in a quantity calculated to yield a magnetic layer of 50 nm in thickness, and while the magnetic layer was still wet, oriented with magnets having a magnetic force of 0.3 T and dried. After applying a surface smoothing treatment at a rate of 100 m/min, a linear pressure of 300 kg/cm (294 kN/m), and a temperature of 90° C. with a calender comprised solely of metal rolls, the magnetic layer was cured. On the opposite side of the support (from the magnetic layer), a backcoat layer was applied to a thickness of 0.5 μm. The tape was then slit to a ½ inch width. The surface of the magnetic layer was cleaned by a tape cleaning device having a unit of feeding and winding a slit product, in which nonwoven cloth and a razor blade pressed against the magnetic surface, to obtain a tape sample.

### Embodiments 2 to 4

With the exception that the mean particle diameter of the diamond powder in the magnetic layer coating liquid and the dried thickness of the magnetic layer were varied as indicated in Table 1, sample tapes were prepared in the same manner as in Embodiment 1.

### Embodiment 5

With the exception that a ferromagnetic metal powder having the mean major axis length shown in Table 1 was employed as the ferromagnetic powder, a sample tape was prepared in the same manner as in Embodiment 1.

### Embodiments 6 and 7

With the exceptions that ferromagnetic metal powders having the mean major axis lengths shown in Table 1 were employed as the ferromagnetic powder and the mean particle diameter of the diamond powder in the magnetic layer coating liquid and the dried thickness of the magnetic layer were varied as shown in Table 1, sample tapes were prepared in the same manner as in Embodiment 1.

### COMPARATIVE EXAMPLE 1

With the exceptions that the electron beam-curing resin employed in the coating liquid for the undercoating layer was replaced with a thermosetting (isocyanate) resin and a heat treatment was applied for 48 hours at 70° C. without electron beam irradiation, a sample tape was prepared in the same manner as in Embodiment 2.

### COMPARATIVE EXAMPLE 2

With the exception that 10 parts of α-Al₂O₃ powder (mean particle diameter: 100 nm) were added instead of two parts of diamond powder to the magnetic layer coating liquid, a sample tape was obtained in the same manner as in Embodiment 2.

### COMPARATIVE EXAMPLES 3 AND 4

A lower layer coating material obtained by the method described further below was applied in a quantity calculated to yield a dry thickness of 1.5 μm—over a cured undercoating layer in Comparative Example 3 and over a nonmagnetic support, without forming an undercoating layer, in Comparative Example 4—to form a lower layer (nonmagnetic layer), and a magnetic layer coating liquid was applied thereover to form a magnetic layer; otherwise, sample tapes were obtained in the same manner as in Embodiment 2.

Lower Layer (Nonmagnetic Layer) Coating Liquid

| | | |
|---|---|---|
| Inorganic nonmagnetic powder, α-iron oxide | 85 | parts |
| Mean major axis length: 0.15 μm | | |
| Mean acicular ratio: 7 | | |
| Specific surface area by BET method: 52 m²/g | | |
| Carbon black | 15 | parts |
| Mean particle diameter: 20 nm | | |
| Sulfonic acid group-containing vinyl chloride copolymer | 13 | parts |
| Sulfonic acid group-containing polyurethane resin | 6 | parts |
| Phenylphosphonic acid | 3 | parts |
| Cyclohexanone | 140 | parts |
| Methyl ethyl ketone | 170 | parts |
| Butyl stearate | 2 | parts |
| Stearic acid | 3 | parts |

The various above-listed components were kneaded in an open kneader and dispersed in a sandmill, and the dispersion obtained was filtered using a filter having a mean pore diameter of 1 μm to prepare a lower layer coating liquid.

### COMPARATIVE EXAMPLE 5

With the exception that a magnetic layer coating liquid was directly applied to a nonmagnetic support to form a magnetic layer without forming an undercoating layer, a sample tape was obtained in the same manner as in Embodiment 2.

Evaluation Method

(1) Magnetic Layer Surface Roughness Measurement

The centerline average roughness Ra of an area of about 250 μm×250 μm on the magnetic layer surface was measured with a TOPO3D surface roughness meter made by WYKO Corp.

(2) Coating Durability Evaluation

The magnetic layer surface of a sample was observed with a microscope at a magnification of 50 following 10,000 passes at 3 m/s with a linear tester, and the presence or absence of running-induced scratching of the coating was determined.
O: No scratching was observed.
X: Scratching or peeling of the film was occurred.
   (3) Measurement of Electromagnetic Characteristics

A ½ inch tape was run at 3 m/s using a linear tester and recording and reproduction were conducted with the tape pressed against the head. Recording was conducted with an MIG head (gap length: 0.2 μm, track width: 14 μm) with a saturation magnetization of 1.4 T. The recording current was optimized for each tape. An anisotropic MR head with a shield spacing of 0.2 μm (track width: 7 μm) and an element thickness of 25 nm was employed as the reproduction head. The S/N ratio at a recording wavelength of 0.3 μm was measured for the above evaluation system.

TABLE 1

| | | | Magnetic layer | | | |
|---|---|---|---|---|---|---|
| | | | | Particle | Ferromagnetic | |
| | | | | diameter of | powder | |
| | Undercoating | Nonmagnetic | Thickness | diamond | | Size |
| | layer resin | lower layer | (nm) | (nm) | Type | (nm)¹⁾ |
| Embodiment 1 | Electron beam | None | 50 | 50 | BaFe²⁾ | 20 |
| | curing resin | | | | | |
| Embodiment 2 | Electron beam | None | 80 | 100 | BaFe | 30 |
| | curing resin | | | | | |
| Embodiment 3 | Electron beam | None | 100 | 80 | BaFe | 30 |
| | curing resin | | | | | |
| Embodiment 4 | Electron beam | None | 150 | 180 | BaFe | 30 |
| | curing resin | | | | | |
| Embodiment 5 | Electron beam | None | 50 | 50 | MP³⁾ | 30 |
| | curing resin | | | | | |
| Embodiment 6 | Electron beam | None | 100 | 80 | MP | 45 |
| | curing resin | | | | | |
| Embodiment 7 | Electron beam | None | 100 | 80 | MP | 60 |
| | curing resin | | | | | |
| Comp. Ex. 1 | Thermosetting | None | 80 | 100 | BaFe | 30 |
| | resin | | | | | |
| Comp. Ex. 2 | Electron beam | None | 80 | None | BaFe | 30 |
| | curing resin | | | | | |
| Comp. Ex. 3 | Electron beam | Formed | 80 | 100 | BaFe | 30 |
| | curing resin | | | | | |
| Comp. Ex. 4 | None | Formed | 80 | 100 | BaFe | 30 |
| Comp. Ex. 5 | None | None | 80 | 100 | BaFe | 30 |

| | Surface roughness | | |
|---|---|---|---|
| | Ra (nm) | Coating durability | S/N (dB) |
| Embodiment 1 | 1.5 | ∘ | 4.5 |
| Embodiment 2 | 1.4 | ∘ | 3.5 |
| Embodiment 3 | 1.4 | ∘ | 3.0 |
| Embodiment 4 | 1.5 | ∘ | 3.0 |
| Embodiment 5 | 1.4 | ∘ | 3.0 |
| Embodiment 6 | 1.5 | ∘ | 2.5 |
| Embodiment 7 | 1.5 | ∘ | 2.0 |
| Comp. Ex. 1 | 2.5 | ∘ | 0.0 |
| Comp. Ex. 2 | 1.3 | x | 3.0 |
| Comp. Ex. 3 | 2.5 | ∘ | 0.0 |
| Comp. Ex. 4 | 3.0 | ∘ | −2.0 |
| Comp. Ex. 5 | 5.5 | x | −4.0 |

¹⁾The mean plate diameters are shown for barium ferrite, and the mean major axis lengths are shown for ferromagnetic metal powder.
²⁾“BaFe” means barium ferrite.
³⁾“MP” means ferromagnetic metal powder.

Evaluation Results

The magnetic tapes of Embodiments 1 to 7, in which an undercoating layer comprising a radiation-curing resin as a main component was provided on a nonmagnetic support and a magnetic layer containing diamond powders was provided thereover, exhibited surface roughnesses Ra of equal to or less than 2 nm, indicating good surface smoothness. The magnetic tapes of Embodiment 1 to 7 had good coating durability and exhibited high S/N ratios and electromagnetic characteristics.

By contrast, although the magnetic tape of Comparative Example 1—in which the resin employed in the undercoating layer was replaced with a thermosetting resin—exhibited good coating durability, the magnetic layer surface was rough and the S/N ratio deteriorated. This was thought to have resulted from winding of the support in the heat treatment used to cure the thermosetting resin, transferring the surface roughness of the backcoat layer to the magnetic layer.

In the magnetic tape of Comparative Example 2, in which the two parts of diamond powder in the magnetic layer were replaced with 10 parts of α-A₂O₃ powder but which otherwise was prepared in the same manner as in Embodiment 2, coating durability deteriorated. These results indicated that the diamond powder contributed greatly to improving coating durability even when added in a small amount relative to the α-Al₂O₃ powder.

In the magnetic tapes of Comparative Examples 3 and 4, where a magnetic layer was provided on a nonmagnetic layer containing nonmagnetic inorganic powder, the surface of the magnetic layer was rough and the S/N ratio deteriorated. This indicated that when a magnetic layer was provided over a lower layer containing particulate matter, it was impossible to form a magnetic layer of good surface smoothness.

In the magnetic tape of Comparative Example 5, in which a magnetic layer was directly provided on a nonmagnetic support, the surface of the magnetic layer was extremely rough, the S/N ratio deteriorated substantially, and coating durability was poor.

These results indicate that the magnetic recording medium of the present invention affords both good electromagnetic characteristics and good coating durability.

The magnetic recording medium of the present invention has both excellent electromagnetic characteristics and high coating durability, and is suited for use as a magnetic recording medium for high-density recording having a thin magnetic layer.

1. A magnetic recording medium comprising an undercoating layer comprising a radiation-curing resin as a main component and a magnetic layer comprising a ferromagnetic powder and a binder in this order on a nonmagnetic support, wherein
said undercoating layer comprises no particulate matter, and
said magnetic layer comprises a diamond powder.

2. The magnetic recording medium according to claim 1, wherein, where the thickness of said magnetic layer is denoted as d (nm), said diamond powder has a mean particle diameter ranging from 0.7 d to 1.3 d (nm).

3. The magnetic recording medium according to claim 1, wherein said diamond powder has a mean particle diameter ranging from 50 to 150 nm.

4. The magnetic recording medium according to claim 1, wherein said diamond powder has a mean particle diameter ranging from 50 to 100 nm.

5. The magnetic recording medium according to claim 1, wherein the thickness of said magnetic layer ranges from 30 to 200 nm.

6. The magnetic recording medium according to claim 1, wherein the thickness of said magnetic layer ranges from 30 to 100 nm.

7. The magnetic recording medium according to claim 1, wherein the thickness of said magnetic layer ranges from 30 to 80 nm.

8. The magnetic recording medium according to claim 1, wherein the thickness of said undercoating layer ranges from 0.1 to 1.0 μm.

9. The magnetic recording medium according to claim 1, wherein the thickness of said undercoating layer ranges from 0.2 to 0.8 μm.

10. The magnetic recording medium according to claim 1, wherein said radiation-curing resin has an alicyclic ring structure.

11. The magnetic recording medium according to claim 1, wherein said magnetic layer has a surface roughness Ra equal to or less than 2 nm.

12. The magnetic recording medium according to claim 1, wherein the variation in thickness of said undercoating layer is equal to or less than 50 percent.

13. The magnetic recording medium according to claim 1, wherein the variation in thickness of said undercoating layer ranges from 0 to 25 percent.

14. The magnetic recording medium according to claim 1, wherein said ferromagnetic powder is a hexagonal ferrite powder having a mean plate diameter ranging from 10 to 35 nm or a ferromagnetic metal powder having a mean major axis length ranging from 20 to 70 nm.

15. A method of magnetically recording a signal on a magnetic recording medium and/or reproducing said signal in a linear magnetic recording and reproducing device, wherein
said magnetic recording medium is the magnetic recording medium according to claim 1.
